(19) United States
(12) Patent Application Publication
(10) Pub. No.: US 2004/0101603 A1
(43) Pub. Date: May 27, 2004

(54) Restructured seafood products using surimi binder

(76) Inventors: Andrzej Strak, Lynnwood, WA (US); William G. McKee, Edmonds, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/664,819

(22) Filed: Sep. 17, 2003

Related U.S. Application Data
(60) Provisional application No. 60/412,059, filed on Sep. 18, 2002.

(51) Int. Cl. A23K 1/00

(52) U.S. Cl. 426/332

(57) ABSTRACT

The present invention is related to methods for making seafood products. The method includes treating the surfaces of more than one seafood portion with a phosphate and, optionally, a salt for a sufficient time and at a sufficient temperature to produce surface-modified seafood portions. The surface-modified seafood portions are coated with a surimi-based binder, and the coated portions are then formed into one or more products. The surface modification causes the rearrangement of proteins, thus making available binding sites for the surimi-based binder. The surimi-based binder has suitable functional groups that can attach to the binding sites either through covalent or hydrogen binding. The product temperature is elevated to set the binder. The binding method according to the invention thus provides for greater cohesion between seafood portions.

### CROSS-REFERENCE TO RELATED APPLICATION

This application claims the benefit of U.S. Provisional Application No. 60/412,059, filed on Sep. 18, 2002, expressly incorporated herein by reference in its entirety.

### FIELD OF THE INVENTION

The present invention is related to a method whereby the surfaces of seafood portions are modified. The surface-modified seafood portions are coated with a surimi-based binder. The portions can be formed in a random or ordered manner, and the temperature of the products is elevated to set the binder, and produce restructured seafood products.

### BACKGROUND OF THE INVENTION

Some seafood products are desired by restaurants and consumers to come in a particular shape. Unfortunately, processing seafood into portion-controlled shapes entirely out of whole muscle is expensive, given the limited availability of seafood. Consumers also tend to prefer products made from a single ingredient of seafood. An industry has therefore arisen from the need to provide seafood products that resemble single-ingredient whole seafood products. Because it is inefficient to utilize only the larger fish to cut whole portions for seafood steaks and burgers, many of the shaped or portion-controlled seafood products are, in reality, aggregates of smaller chunks and pieces bonded to one another to be made to appear like single-ingredient, whole seafood. These products are said to be “restructured” or “formed” products, as differentiated from products made entirely from a single-ingredient whole seafood. “Single-ingredient whole seafood” product means that the seafood product is harvested from a single animal and the product has not been broken apart and recombined.

Restructured seafood products require a binder to hold the individual pieces as one unit. Desirably, the binder must be able to hold the aggregate product during handling, frying, cutting, baking, and other cooking procedures typically performed on food. Surimi or surimi-based products are typically used as a binder. Surimi is a minced fish product. Other binders are also known in the art, such as locust gums, starch binders, and egg whites. However, some binders have allergens or do not provide sufficient binding strength so that the products can withstand handling. For example, reference is made to U.S. Pat. No. 5,188,854 to Hartman. According to Hartman, surimi-based binder is combined with frozen fish pieces and formed into the desired shape. Hartman describes that the amount of surimi-based binder necessary to bind the seafood portions is in the range of 10% to 20% by weight.

Formed or restructured seafood products desirably should have a flavor and texture comparable to single-ingredient whole seafood products. In many cases, the surimi-based binder is not the same species of seafood that is being bonded. The different flavor of surimi detracts from the natural flavor of the seafood being emulated. As a consequence, flavoring needs to be added to impart the desired seafood flavor. The addition of so much surimi and foreign flavors detracts from the realism sought in the restructured seafood product. Consumers may also disfavor product labeled as having artificial or added flavorings. The high amount of surimi present in these products also visually detracts from the appearance as compared with a single-ingredient whole seafood product. The high amounts of surimi and surimi-based binder create a visually discernible matrix surrounding the individual seafood pieces that is noticeable between the binder and the pieces being bound. Consumers therefore can identify the restructured products that have high amounts of surimi binder products from the single-ingredient whole seafood products. For a variety of reasons, consumers find the conventional restructured products less appealing than single-ingredient whole seafood products. It is therefore desirable to improve the existing methods of making restructured or formed seafood products that consumers will find more appealing.

In view of the aforementioned disadvantages with the typical restructured seafood products including fillets and chunks there is a need for a new binding method. The present invention fulfills this need and provides further related advantages.

### SUMMARY OF THE INVENTION

The present invention is related to methods for making seafood products. In one embodiment of the invention, a method includes treating the surfaces of more than one seafood portion with a phosphate and, optionally, a salt for a sufficient time to produce surface-modified seafood portions. The surface-modified seafood portions are coated with a surimi-based binder, and the coated portions are then formed into one or more products. The surface modification causes the rearrangement of proteins, thus making available open binding sites for the surimi or surimi-based binder. The surimi-based binder has suitable functional groups that can attach to the binding sites, either through covalent binding or hydrogen binding. The binding method according to the invention thus provides for greater cohesion between seafood portions.

The products made from the method according to the invention can have randomly arranged seafood portions, or the product can be made from methodically arranged seafood portions, such as fillets, that can be ordered, oriented, or placed in a manner that preserves the natural texture and appearance of the seafood from which the fillets are harvested.

One of the advantages of deriving a binding substance from proteins native to the seafood portions being bound is that less foreign seafood substances end up in the final product. Foreign seafood detracts from the desired flavor and texture of the products, giving them an unnatural appearance and flavor. To correct this unnaturalness, conventional processes must add supplemental seafood flavoring. Consumers tend to disfavor highly processed foods. Accordingly, any method that improves the similarity between restructured products and those made entirely from a single-ingredient whole seafood are highly desired.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a flowsheet of an embodiment of a method according to the present invention;

FIG. 2 is a flowsheet of an embodiment of a method according to the present invention;

FIG. 3 is a flowsheet of an embodiment of a method according to the present invention; and

FIG. 4 is a flowsheet of an embodiment of a method according to the present invention.

### DETAILED DESCRIPTION OF THE PREFERRED EMBODIMENT

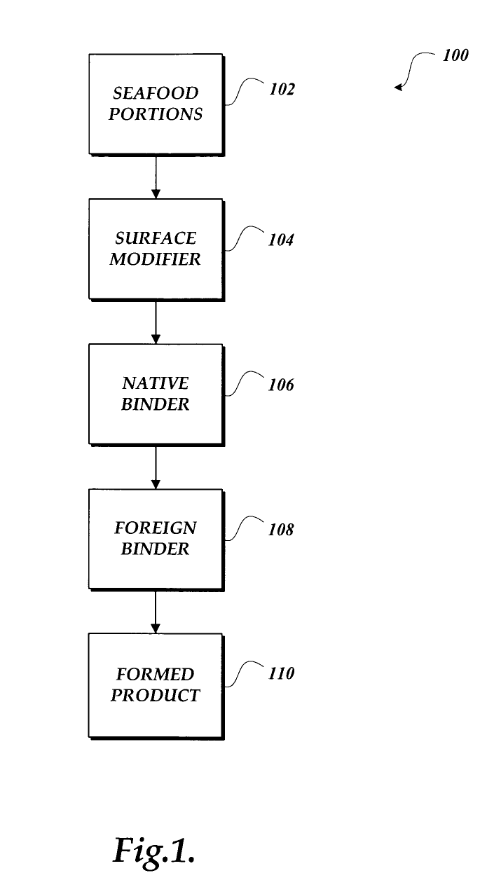

Referring to FIG. 1, a process 100 for producing restructured seafood products of improved strength and resistance to damage during handling, defrosting, and cooking, is illustrated. The process includes obtaining seafood portions that can include small chunks or comparatively larger fillets, block 102. The process includes adding a surface-modifying agent to modify the surfaces of the seafood portions, block 104. The surface-modifying agent includes a salt, such as sodium chloride, and a phosphate, such as tetrasodium pyrophosphate. Alternatively, only the phosphate can be used. According to the invention, salt and phosphate are used to modify the native proteins found in the seafood portions to create a gelatinous binding material. A native binder is a binding material produced from the surfaces of the seafood portions being bound, block 106. The process includes adding a foreign binder to the seafood portions to coat the foreign binder on the seafood portions, block 108. A foreign binder is a binder produced from a source other than the surfaces of the seafood portions being bound. The foreign binder can be a surimi-based binder. The process includes forming the seafood portions into a restructured product, block 110. The products made according to the invention include seafood burgers made from randomly arranged small chunks and laminated products made from the orderly arrangement of larger fillets. The process includes elevating the temperature of the products to set the binder and hold the individual chunks or fillets as a unit.

In one embodiment, the process can be employed to make “burger” type restructured products that require a large degree of cohesiveness to withstand the process of defrosting and subsequent handling prior to cooking, during cooking, and serving. However, the methods disclosed herein are suitable for making any restructured or formed product. The product can have the appearance, texture, and flavor comparable to a single-ingredient whole seafood product.

According to the invention, seafood portions are surface modified causing the rearrangement of proteins, thus making available “open” binding sites for a surimi or surimi-based binder to attach thereto. According to the invention, the surface treatment is characterized as a “milder” treatment than what is conventionally thought of as fully extracting salt-soluble proteins from fish. The surimi-based binder has suitable functional groups that can attach to the binding sites of the gelatinous material, either through covalent bonding or hydrogen bonding. For example, it was found that treating the seafood portions at a temperature below the freezing point of water and for a short duration with phosphate and, optionally, salt would result in the creation of the binding sites. The binding sites formed on the seafood portions are then used in combination with a surimi or surimi-based binder to bond the seafood portions together. It is believed that phosphate, and/or salt, will “solubilize” or “denature” certain proteins, such as myosin. Typically, in nature, these proteins are coiled or folded together. By adding a phosphate and/or salt, the myosin protein is “uncoiled,” “unfolded,” or “opened” to create the binding sites. The actin proteins are affected to a lesser degree than myosin. It is believed that the majority of the binding sites will be created from myosin. The surface treatment is time and temperature controlled to avoid the complete or near elimination or extraction of the proteins that contribute to the binding sites.

The brief treatment duration is advantageous because it leads to short overall processing times for the products. To produce the gelatinous material, the surfaces of the seafood portions are treated with the phosphate and, optionally, salt in the quantities described below, and for a sufficient time period to produce sufficient gelation, typically about 30 seconds. However, the time period can be about 30 seconds to about 2 to about 3 minutes. It is desirable to minimize the treatment period, which results in greater productivity. The upper limit is about 10 minutes depending on the amount of surface-modifying agent and temperature. Beyond 10 minutes, the process is inefficient, and furthermore longer treatment duration periods may totally extract the desirable proteins. The surface treatment can be carried out on the seafood portions while in a frozen condition. Throughout the blending process, it is advantageous that the temperature not exceed about 28° F. Preferably, the temperature should be about 24° F. to about 26° F. It is advantageous to minimize the processing time to be as little as possible for economic advantage while at the same time assuring sufficient phosphate and, optionally, salt are available to produce the desired binding sites. The gelatinous material by itself is not considered sufficient for most binding applications; therefore, a surimi-based binder can be applied to the portions to attach to the binding sites of the various seafood portions, thus holding two or more pieces together after the binder has set. The gelatinous material and surimi-coated portions are held together by forces believed to be attributed to hydrogen and covalent bonding occurring between the proteins of the foreign binder and the proteins derived from the surfaces of the fish portions.

The process results in restructured products having superior properties, as compared to products having only surimi-based binders. Products made according to the invention are capable of withstanding the food preparation process, including defrosting and cooking. The bond created between individual portions appears seamless, giving the impression of a single-ingredient whole seafood product. Phosphate is believed to aid in creating the protein binding sites and gelatinous binding material without imparting a “salty” flavor. Optionally, salt can also be used to treat seafood portions to modify the surfaces, either alone or in combination with phosphate. Conventional methods rely on applying a continuous surimi binder around seafood portions that have not had their surfaces modified. The conventional methods rely on embedding the seafood portions within the surimi. The surimi acts as a frame in which the individual seafood portions are embedded. The large amount of surimi-based binder used in conventional products produces a matrix that is visually discernible to the human eye and consumers are able to discern that the product is not a single-ingredient whole seafood product. Because the binding method of the present invention can drastically reduce the amount of foreign binder used, the products have minimized or no visual appearance of a binding matrix; therefore, consumers find the products made by the invention more appealing.

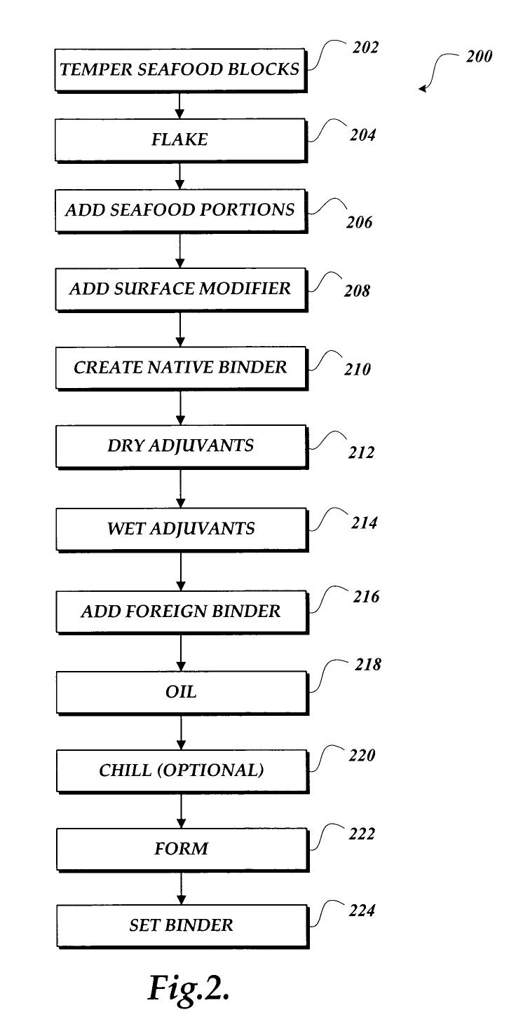

Referring now to FIG. 2, one embodiment of a process 200 for producing restructured seafood products is illustrated. In this embodiment of the invention, suitable seafood portions for making into restructured products are obtained from blocks of salmon fillets. The salmon blocks are tempered to about 25° F. before hydroflaking, block 202. Tempering advantageously softens the surfaces of the salmon blocks, which facilitates breaking the blocks apart. While salmon is a suitable seafood to use in the present invention, other embodiments of the invention may utilize seafood from other species, including whitefish and shellfish. Hydroflaking, block 204, refers to mechanically attriting the salmon fillets into smaller pieces. In one embodiment for making burgers, excessively large chunks (greater than about 1.0 ounce) and small particles are to be avoided. However, in other embodiments, such as producing laminated fillet products, hydroflaking can be omitted, and single-ingredient whole seafood fillets are methodically arranged or grouped and then bonded into a desirable shape utilizing a mold. Hydroflaking is one method to produce the seafood portions depicted in block 206. Filleting a fish or a plurality of fish of the same species is another. Alternatively, tempering and hydroflaking, blocks 202 and 204, respectively, can be omitted when suitable seafood portions are obtainable on the market or otherwise through any supply channel. The portions are derived from mainly one species of fish, such as salmon, and can come from more than one individual fish. Once seafood portions are obtained in block 206, the portions are loaded into a suitable mixer, including a ribbon blender, for example. The seafood portions are not mixed at this stage. A surface-modifying agent or agents are added in sufficient quantities to the seafood portions, block 208. A surface modifier useful in the invention is believed to have the effect of dissolving proteins to free up binding sites from the muscle flesh of the seafood portions, as described above. The surface modification produces a gelatinous material on the surfaces of the seafood portions. In one embodiment, the surface modifier includes tetrasodium pyrophosphate (TSPP) and, optionally, sodium chloride. However, other suitable modifying agents will become known to the person of ordinary skill with the reading of this disclosure. The salt and the phosphate are weighed in the proportions that are provided below and added to the seafood portions. Following the addition of the surface modifier or modifiers, mixing and treating with the surface modifier proceed for a sufficient time period until the surfaces become “sticky” to the touch, which takes about 30 seconds to about 2 to about 3 minutes. This gelation process is represented by block 210. Conventional processes for binding seafood do not contemplate deriving a gelatinous material from the seafood portions to be used in binding, as in the present invention. Conventional processes for binding seafood do not contemplate freeing up binding sites from the proteins native to the seafood portions being bound but, rather, use binders from foreign (i.e., different or external) protein sources.

After the step of modifying the surfaces of the seafood portions, dry adjuvants may be added as depicted in block 212. Dry adjuvants can include spices, colorings, both artificial and natural, flavorings, and other desirable ingredients. In one embodiment, garlic powder and white pepper are added and mixed in the blender until uniformly distributed, which takes about 30 seconds. A further dry adjuvant may be added, including rehydrated onion. The onion is mixed until uniformly distributed, which takes about 30 seconds. After addition of the dry adjuvants, wet adjuvants can be added, as depicted in block 214. Wet adjuvants include water and/or additional colorings, flavorings, spices, including lemon juice, and mesquite flavoring. The wet ingredients are mixed until uniformly distributed, which takes about one minute. Any of the wet and dry adjuvants may be omitted in instances when it is desired, or out of consideration of consumer demands. Following the addition of the wet adjuvants, a foreign binder is added as depicted in block 216. After addition of the foreign binder, mixing is resumed until the foreign binder is coated onto the surfaces of the seafood portions, which can take about 2 to about 3 minutes. A foreign binder is a binder that is derived from sources other than from the surfaces of the seafood portions being bound. It is possible that a foreign binder can be derived from the same species of seafood and even from the same seafood from which the portions are derived. This would have the advantage of using the same species of seafood for the binder and the bound portions to preserve the natural seafood flavor.

Foreign binders include surimi-based binders. In one embodiment, a suitable foreign binder includes “A” or “AA” grade Alaska Pollock surimi, potable water, PENBIND 1000 (a modified potato starch by the Penford Food Ingredient Company of Denver, Colo.), salt, natural food coloring, and tetrasodium pyrophosphate, in the proportions described below. All the ranges and percentages are given on an ingredient weight basis prior to mixing. It is to be appreciated that all the ranges and percentages are approximations and can deviate from the stated amounts. Surimi is a widely available seafood product made from minced fish. In one embodiment of a foreign binder, Pollock surimi comprises about 40% to about 70% of the foreign binder, potable water comprises about 23% to about 53% of the foreign binder, PENBIND 1000 comprises about 5% of the foreign binder, salt comprises about 1% or less of the foreign binder, natural food coloring comprises about 2% of the foreign binder, and tetrasodium pyrophosphate comprises about 1% or less of the foreign binder. Sometimes it is desirable that water exceeds 30% by weight of the binder. The percentages of ingredients above are rounded to the next highest whole percent. The method of making the foreign binder will be described in greater detail below. As an alternative to, or in addition to surimi-based foreign binders, other foreign binders can be added. Foreign binders other than surimi-based binders include locust gums, starch binders, and egg whites. However, some of these binders may contain allergens and are not as effective at binding the seafood portions together as a surimi-based binder.

As an alternative to the methods represented by FIGS. 1 and 2, the surimi-based binder can be provided with sufficient additional phosphate and, optionally, salt to modify the surfaces of the seafood portions as described above, thus eliminating the necessity to pretreat the seafood portions in a separate step. In other words, the surface treatment and surimi-based binder coating steps can be performed simultaneously. The combined amount of salt and/or phosphate in the final product is about 1% or less.

Because of the surface modification used to create a gelatinous binding material from the seafood portions themselves, the quantity of the foreign binder that is added is considerably reduced, compared to the amount of binder needed when surface modification is not used. In one embodiment, the amount of foreign binder in a seafood product is in the range from about 3% to about 7% by weight of the product. The foreign binder, in products made in accordance with the invention, can be less than 10% by weight of the product. Sometimes it is desirable that the binder comprises less than 5% by weight of the product. One of the advantages of using less surimi-based binder is that there is less foreign seafood present to dilute the natural and desirable flavor of the seafood portions. In addition to detracting from the flavor, amounts of foreign binders of 10% or greater in seafood products would also impact the visual appearance of the finished restructured product, such as creating a visible binder matrix that can be perceived by the human eye as a layer surrounding the individual seafood pieces. Accordingly, it is preferable to treat or pretreat the seafood portions to modify the surfaces and minimize the use of foreign binders.

Referring again to FIG. 2, following the addition of the foreign binder, butter-flavored oil is added, as depicted in block 218. The butter-flavored oil is mixed with the other ingredients until dispersed, which takes about 1 to about 2 minutes. The mixing is stopped when the contents are of uniform color and have a heavy thick texture. The contents of the blender are placed in any suitable container. If the contents appear too soft and runny for forming into suitable restructured products, the contents can be chilled in a freezer prior to forming, block 220. Once a suitable temperature has been reached, the contents are transferred to a forming machine and formed into the desired shape, block 222. A suitable forming machine is a Koppens/Formax machine. The machine can be used to shape the mixture into round “burger” type products. The mixing and forming of surface-modified seafood portions with surimi-based binder creates a product wherein the seafood portions are randomly arranged throughout the product. Once the restructured products are formed, the binder can be set by elevating the temperature of the products to above 32° F. for a sufficient time, block 224. In one embodiment, the products are transferred by belt conveyor to a fry line in a raw state and parfried at about 350° F. for about 15 seconds. In one embodiment, it is preferred that only the exterior surface or about 1 mm or less of the products' exterior surface be cooked. Such parfrying advantageously imparts a “non-stick” coating on the outermost surfaces of the product. After parfrying, the restructured products are individually quick-frozen and packaged in any suitable manner, depending on the ultimate destination and use.

Throughout the blending and forming process, blocks 206 through 222, it is preferred that the temperature of the seafood portions does not exceed 28° F. A target temperature for mixing and forming the product is about 24° F. to about 26° F. While in a frozen condition, at the temperatures described, the seafood chunks are less prone to disintegrate into pieces too small for the binder to effectively coat the surfaces of the smaller pieces. However, in other embodiments of the invention, when binding the larger fillets, for example, the fillets can be allowed to have a temperature in excess of 28° F., such as about 32° F. With fillets, a non-frozen condition is desired because the fillets can be made pliable to fit into the desired mold and to readily take on the configuration of the mold.

In one embodiment of the invention, a restructured seafood product includes seafood portions held together with a combination of a gelatinous material derived from proteins native to the seafood portions and a foreign binder. In one embodiment, the restructured seafood product includes about 3% to about 7% by weight of a surimi-based foreign binder.

Representative weight percents of ingredients to make the restructured seafood product are as follows. It can be seen that phosphate and/or salt each can comprise about 1% by weight or less. All the percentages are given on an ingredient basis prior to mixing. All percentages are approximations and can deviate from the stated amounts. Some of the ingredients may be omitted, if desired.

| Ingredient | Percent (%) |
|---|---|
| Salmon fillet block portions or salmon fillets | 80.90 |
| Butter-flavored oil | 5.00 |
| Surimi-based binder | 5.00 |
| Rehydrated minced onion | 4.00 |
| Water | 2.20 |
| Lemon juice | 1.20 |
| Salt | 0.55 |
| Tetrasodium pyrophosphate | 0.45 |
| Natural red color R-722 | 0.30 |
| Garlic powder | 0.25 |
| White pepper fine ground | 0.10 |
| Mesquite smoke flavor | 0.05 |

One embodiment of a method for making the surimi-based foreign binder of block 216 is as follows. Surimi blocks are tempered to about 24° F. to about 25° F. and cut into pieces weighing about one pound. Surimi can be derived from Pollock, whitefish, salmon, or other seafood. Tetrasodium pyrophosphate and salt are weighed and set aside. Water and PENBIND 1000 are weighed and mixed together until hydrated, then set aside. The chunks of surimi are added to a bowl chopper and processed. The tetrasodium pyrophosphate and salt are added to the surimi and mixed until the contents are thoroughly combined, which takes about 2 to about 3 minutes. The PENBIND 1000 and water mixture is gradually added. The chopping is resumed for about 5 to about 6 minutes until a uniform, smooth, shiny texture develops. The contents are refrigerated until needed as a foreign binder in the binding methods described herein.

In another aspect of the present invention, laminated seafood fillet products are produced. The products are made from two or more fillets arranged in the product to provide the appearance of being a single-ingredient whole seafood product. The fillets can come from different individuals of the same species. The seafood fillet portions can come in weights up to 4 ounces. The process of producing laminated fillet products uses the surface-modifying technique supplemented with foreign binder methods, described above, under the time and temperature conditions provided. Alternatively, the fillets can also be thawed and nonfrozen for increasing the ability to be molded into desirable shapes, provided that the high temperatures do not extract the proteins necessary for binding. The fillet pieces can be methodically arranged so that the natural texture of single-ingredient whole seafood is reproduced by aligning the texture of the individual fillets in a methodical, regular, consistent, or aligned manner. This product is to be contrasted with the randomly placed seafood portions in the “burger” type product described above. The grouping of fillets in a regular manner can produce a restructured product that has the natural flakiness of a single-ingredient whole seafood product. The texture throughout the product made in this manner is comparable to a single-ingredient whole seafood product. However, the product of the invention would be made up of more than one portion bonded with other portions in a manner to produce a consistent and regular texture throughout. The process can produce laminated seafood fillet products of increased strength that are capable of withstanding most cooking processes, including portioning, grilling, and related handling, without breaking apart. The products can further be produced in molds that are shaped like single-ingredient whole seafood to produce a shape and appearance similar to a single-ingredient whole seafood. The molds can have rounded or tapered surfaces to reproduce the middle or dorsal part of a fish. As with the previous embodiments, wherein the surface is modified to produce a gelatinous binding material from proteins native to the seafood, this aspect of the invention also produces a gelatinous binding material through surface modification from the native proteins of the fillet portions, and is combined with a foreign binder, such as a surimi-based binder, to bind the fillets together and to prevent their separation under stress during portioning, cooking, and handling.

The surface-modifying binding methods described herein are also effective in one embodiment wherein the modifying agents can be dissolved in a marinade and applied to the seafood portions, such as chunks or fillets, with the marinade.

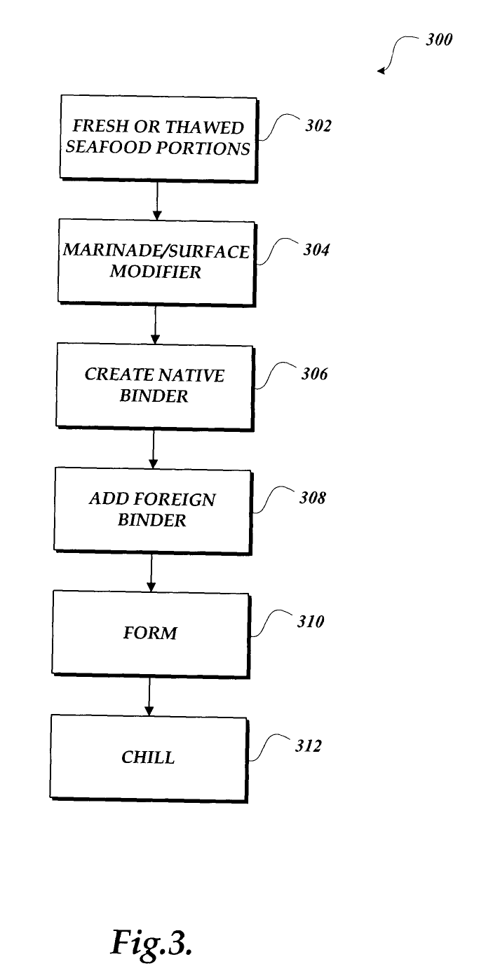

Referring now to FIG. 3, one embodiment of a process 300 for producing laminated seafood products, whereby a surface modifier is added as part of a marinade, is illustrated. In one embodiment, the process begins by obtaining fresh or thawed seafood portions, such as fillets, that are chilled or thawed, depending on the circumstances, to greater than 28° F., such as about 32° F., as depicted in block 302. After obtaining the fresh or thawed seafood fillets, a marinade including one or more protein modifiers is added to the seafood portions, as depicted in block 304. As with the previous embodiments, protein modifiers include tetrasodium pyrophosphate (a phosphate) and, optionally, sodium chloride (a salt). The protein modifier provides for the production of a gelatinous material from the proteins native to the fresh or thawed fillets obtained in block 302. The protein modifier can be added together with other adjuvants constituting the marinade, as depicted in block 304. In one embodiment, the marinade includes a water solution, wherein salt comprises about 0.5% to about 10% by weight, phosphate comprises about 3% to about 7% by weight; and dextrose, flavors, and antioxidants in the desired quantities. The marinade can be introduced to the fillets either through injection or passive soaking methods. As with the previous embodiments, the treatment time and temperature is controlled to produce enough binding sites, but not overtreated where desirable proteins are completely extracted from the seafood.

Following the addition of the marinade together with the surface modifier, the fillets are tumbled by hand or in a rotating drum until the fillets have a sticky constituency, which indicates the production of the desired gelatinous binding material, block 306. A foreign binder, such as a surimi-based binder, is also added to the fillets, as depicted in block 308. The foreign binder can be the surimi-based binder previously described. The fillets are further tumbled by hand or in a rotating drum to coat the fillets with foreign binder.

The fillets are formed to any desired shape by any suitable forming machine or in a mold, as depicted in block 310. The process, according to the invention, produces a non-frozen seafood mixture that can be readily formed into desired shapes. In one embodiment, it is preferred that the seafood portions be maintained at about 32° F. throughout the process. After the forming step, block 310, the laminated fillets can be chilled to below freezing, as depicted in block 312, for preserving. In the embodiments wherein fillets are used, the fillet can be processed in a nonfrozen condition wherein the temperature can be greater than 28° F., such as about 32° F. The nonfrozen seafood portions facilitate the forming process. The resultant laminated seafood product is also characterized by a natural, flaky appearance and exhibits superior properties, such as resistance to damage, as compared to conventional fillet blocks that are produced in a frozen condition.

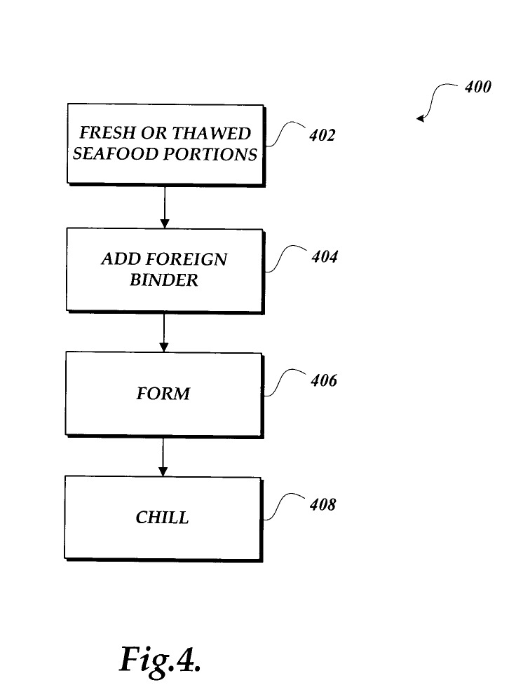

Referring now to FIG. 4, another embodiment of a process 400 for producing a laminated seafood product from fillets is illustrated. In this embodiment, the previously described steps, block 304, of adding a marinade with tetrasodium pyrophosphate and/or salt and generating a binding gelatinous material from the native proteins, block 306, are omitted. Otherwise, the process continues in much the same manner as previously described. A foreign binder is added, block 404. In this embodiment, the fresh or thawed fillets that are obtained in block 402 are also processed in a nonfrozen condition. In one embodiment, the seafood portions are at a temperature of about 32° F. throughout the process. The temperature allows nonfrozen seafood portions to be readily formed into desired shapes in the forming step, block 406. The fillet block can likewise be chilled to any suitable temperature after forming for preserving, block 408.

In addition to producing restructured products and laminated fillet products made from salmon, other seafood is also suitable to be used in the various embodiments according to the present invention. Suitable seafood includes salmon, whitefish, haddock, cod, Pollock, hake, shellfish, and the like.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for making a seafood product, comprising:
(a) treating the surfaces of more than one seafood portion with at least one of phosphate and salt for a sufficient time and at a sufficient temperature to produce surface-modified portions;
(b) coating the modified surfaces with a binder; and
(c) forming the binder-coated, surface-modified seafood portions into a product.

2. The method of claim 1, wherein the sufficient time is about 30 seconds to about 2 to about 3 minutes.

3. The method of claim 1, wherein the sufficient temperature is about 24° F. to about 28° F.

4. The method of claim 1, further comprising treating the surfaces of more than one seafood portion with phosphate and salt.

5. The method of claim 4, wherein the salt is sodium chloride and the phosphate is a polyphosphate.

6. The method of claim 4, wherein the salt is sodium chloride and the phosphate is tetrasodium pyrophosphate.

7. The method of claim 1, wherein the seafood portions are one of at least a salmon, a whitefish, and a shellfish.

8. The method of claim 1, wherein the binder is a surimi-based binder.

9. The method of claim 8, wherein the surimi-based binder is derived from one of at least a salmon, a whitefish, and a shellfish.

10. The method of claim 1, wherein the seafood portions are derived from a salmon and the binder is derived from a salmon.

11. The method of claim 1, wherein the seafood portions are randomly oriented throughout the product.

12. The method of claim 1, wherein the portions are methodically oriented throughout the product.

13. The method of claim 1, wherein the binder comprises about 3% to about 7% by weight of the product.

14. The method of claim 1, wherein the binder comprises 40% to about 70% surimi by weight.

15. The method of claim 1, wherein the binder comprises about 23% to about 53% water by weight.

16. The method of claim 3, wherein the salt comprises about 1% or less by weight of the product.

17. The method of claim 1, wherein the phosphate comprises about 1% or less by weight of the product.

18. The method of claim 1, further comprising elevating the temperature of the product to greater than 32° F. for a sufficient time to set the binder.

19. The method of claim 1, further comprising elevating the temperature of the product to about 350° F. for about 15 seconds.

20. The method of claim 1, further comprising cooking the exterior surface of the product to a depth no more than about 1 mm.

21. The method of claim 1, wherein the temperature of the seafood portions does not exceed 28° F. during steps (a), (b), and (c).

22. The method of claim 1, wherein the temperature of the seafood portions does not fall below 28° F. during steps (a), (b), and (c).

23. The method of claim 1, wherein the average seafood portion weight is no more than 1 ounce.

24. The method of claim 1, wherein the seafood portions are fillets.

25. The method of claim 24, wherein the fillets are molded into a shape in a nonfrozen condition.

26. The method of claim 24, wherein the average weight of fillets does not exceed 4 ounces.

27. The method of claim 1, wherein the product has at least one rounded surface.

28. The method of claim 1, wherein the binder comprises less than 5% by weight of the product.

29. The method of claim 1, wherein the binder comprises greater than 30% water by weight.

30. A method for making a restructured seafood product comprising:
treating a plurality of seafood portions with a phosphate and/or salt for a sufficient time and at a temperature of greater than 28° F. to free binding sites on the surface of the seafood portions; and
adding a binder with functional groups suitable to attach to said binding sites through covalent and/or hydrogen bonding.

31. The method of claim 30, wherein the temperature is about 32° F.

32. A seafood product, comprising:
randomly arranged seafood portions, said portions being bonded together through covalent and/or hydrogen bonding with a combination of a gelatinous material brought about through surface modification of the native proteins in the seafood and less than 10% by weight of a surimi-based binder bonding to said gelatinous material.

33. A seafood product, comprising:
methodically arranged seafood portions, said portions being bonded together through covalent and/or hydrogen bonding with a combination of a gelatinous material brought about through surface modification of the native proteins in the seafood, and less than 10% by weight of a surimi-based binder bonding to said gelatinous material.
